(19) United States
(12) Patent Application Publication
(10) Pub. No.: US 2025/0176033 A1
(43) Pub. Date: May 29, 2025

(54) METHOD AND APPARATUS FOR MULTI-USER DATA DETECTION IN A GRANT-FREE RANDOM ACCESS SYSTEM

(71) Applicant: Korea University Research and Business Foundation, Seoul (KR)

(72) Inventors: Chung Gu KANG, Seoul (KR); Min Sig HAN, Seongnamsi (KR)

(21) Appl. No.: 18/946,710

(22) Filed: Nov. 13, 2024

(30) Foreign Application Priority Data
Nov. 29, 2023 (KR) 10-2023-0169377

(51) Int. Cl. H04W 74/0833; H04B 7/0456; H04L 25/02

(52) U.S. Cl. CPC H04W 74/0833; H04B 7/0456; H04L 25/0202

(57) ABSTRACT

A wireless communication system based on grant-free non-orthogonal multiple access is disclosed. A wireless communication system based on grant-free non-orthogonal multiple access (GF-NOMA) according to an embodiment of the present disclosure may include a transmitting unit comprising a plurality of active users transmitting preambles and data in a grant-free manner without granting resources for data transmission, and a receiving unit that receives preambles and data transmitted from the plurality of active users in a grant-free manner, and detects data corresponding to each active user from among the plurality of active users, wherein each active user from among the plurality of active users transmits the data based on a codebook, and the codebook is a codebook randomly selected by the each active user from a preset codebook set.

### BACKGROUND OF THE INVENTION

### Field of the Invention

The present disclosure relates to a wireless communication system based on grant-free non-orthogonal multiple access, and more particularly, to a method for performing multi-user detection (MUD) on overlapping data symbols transmitted by different combinations of active users by utilizing active user information detected using a pilot and a corresponding active user channel when an active user transmits data symbols and a pilot sequence at the same time in an uplink grant-free multiple access situation through grant-free non-orthogonal multiple access, and an apparatus capable of performing the same.

### Background of the Related Art

The present disclosure considers a massive IoT system in which a number of Internet-of-Things (IoT) sensors (devices or users) are simultaneously multiple-accessed via uplink among intelligent 6G wireless access systems. In conventional 4G mobile communication standards, in order for a number of IoT devices to transmit data simultaneously via uplink, each user must be granted uplink resources required for data transmission through a grant. However, since IoT devices have a small amount of data being transmitted, individually granting resources to a number of IoT users through grants is very inefficient because it requires a lot of signal load for the request and grant process compared to the amount of data being transmitted. Therefore, a grant-free multiple access system has been considered, which activates only some of a plurality of user devices to transmit data symbols and pilot symbols simultaneously without a separate grant process.

### SUMMARY OF THE INVENTION

In a grant-free multiple access situation, when active users have data to send, they transmit the data and preambles (pilots) directly to a resource for which multiple users are competing without receiving a grant for the resource. The present disclosure proposes a multi-user detector (MUD), which is a procedure for receiving spreading data when assuming a grant-free non-orthogonal multiple access situation in which data of active users are spread through a non-orthogonal spreading sequence. In a grant-free non-orthogonal multiple access situation, active users use randomly selected non-orthogonal spreading sequences, so a combination of non-orthogonal spreading sequences used in the received data changes whenever a combination of active users changes. A conventional MUD that does not use deep learning has a problem of high reception complexity and receiver design cost because different MUDs must be designed and implemented for each non-orthogonal spreading sequence combination. In order to solve the foregoing problems, the present disclosure proposes a deep learning-based multi-user detector design scheme that allows data to be received through a same multi-user detection procedure for multiple codebook combinations in a grant-free non-orthogonal multiple access situation where the codebook (spreading sequence) combination of the received data changes.

In order to achieve the foregoing technical tasks, a wireless communication system based on grant-free non-orthogonal multiple access (GF-NOMA) may include a transmitting unit comprising a plurality of active users transmitting preambles and data in a grant-free manner without granting resources for data transmission; and a receiving unit that receives preambles and data transmitted from the plurality of active users in a grant-free manner, and detects data corresponding to each active user from among the plurality of active users, wherein each active user from among the plurality of active users transmits the data based on a codebook, and the codebook is a codebook randomly selected by the each active user from a preset codebook set.

According to one embodiment, all active users from among the plurality of active users may transmit the data based on different codebooks, or at least two active users from among the plurality of active users may transmit the data based on the same codebook.

According to one embodiment, the receiving end may include an active user detector that detects the plurality of active users based on the preambles to acquire active user information, a channel estimator that estimates channels related to the plurality of active users to acquire channel information, and a multi-user detector that detects data corresponding to each active user from among the plurality of active users based on the active user information and the channel information.

According to one embodiment, the multi-user detector may include a preprocessor that performs preprocessing based on the active user information and the channel information to acquire channel modulated codebook information, and a collision-aware multi-user detector that detects data corresponding to each active user from among the plurality of active users based on data received from the plurality of active users and the channel modulated codebook information.

According to one embodiment, at most λ active users from among the plurality of active users may transmit the data based on the same codebook.

According to one embodiment, the collision-aware multi-user detector may include a multi-user shared layer and duplicate user-specific layers as many as λ.

According to one embodiment, the collision-aware multi-user detector may be trained by using L(r, ŝ)=Σₙ₌₀^{λJ-1}Lₙ(r⁽ⁿ⁾, ŝ⁽ⁿ⁾) as a loss function, wherein Lₙ(r⁽ⁿ⁾, ŝ⁽ⁿ⁾)=−Σₘ₌₀^{M}rₙₘ log(ŝₙₘ), J is a number of codebooks included in the preset codebook set, M is a number of codewords included in each codebook, ŝ⁽ⁿ⁾ is an output vector of an n-th user-specific layer, and r⁽ⁿ⁾ is a one-hot vector generated based on the ŝ⁽ⁿ⁾.

According to one embodiment, the preprocessor may acquire an active codebook based on the active user information, acquire a channel associated with the active codebook based on the channel information, and acquire the channel modulated codebook information based on the channel associated with the active codebook and the active codebook.

In addition, a receiving end apparatus of a wireless communication system based on grant-free non-orthogonal multiple access (GF-NOMA) according to an embodiment of the present disclosure may include a transceiver that receives preambles and data from a plurality of active users, an active user detector that detects the plurality of active users based on the preambles to acquire active user information, a channel estimator that estimates channels related to the plurality of active users based on the active user information and the channel information to acquire channel information, and a multi-user detector that detects data corresponding to each active user from among the plurality of active users.

In addition, a method performed by a receiving end of a wireless communication system based on grant-free non-orthogonal multiple access (GF-NOMA) may include receiving preambles and data from a plurality of active users, detecting the plurality of active users based on the preambles to acquire active user information, estimating channels related to the plurality of active users to acquire channel information, and detecting data corresponding to each active user from among the plurality of active users based on the active user information and the channel information, wherein data corresponding to each active user from among the plurality of active users is associated with a codebook randomly selected by each active user from among the plurality of active users.

According to various embodiments of the present disclosure, a single deep learning-based multi-user detector network may perform multi-user detection on received data using a number of combinations of codebooks (spreading sequences), thereby reducing reception complexity and cost.

Furthermore, according to various embodiments of the present disclosure, instead of inputting a channel vector as side-information for designing (training) a multi-user detector as it is into a multi-user detector, the multi-user detector may be effectively trained by considering a vector that simultaneously considers a codebook and a channel through an input preprocessing process as side information, thereby increasing training efficiency and final bit error rate performance.

In addition, according to various embodiments of the present disclosure, a generalized deep learning-based multi-task learning MUD structure may be proposed to distinguish up to λ codebook collisions through λ different user-specific layers, and allow the deep learning-based MUD to distinguish even codebook collisions, thereby allowing a receiver to detect each user's data through a channel even when there occur λ collisions with the same codebook.

The effects of the present disclosure are not limited to the above-mentioned effects, and other effects that are not mentioned herein will be clearly understood by those skilled in the art from the description below.

### BRIEF DESCRIPTION OF THE DRAWINGS

FIG. 1 is a diagram showing an example of a grant-free multiple access system model according to an embodiment of the present disclosure.

FIG. 2 is a diagram for explaining a structure of an SCMA codebook according to one embodiment of the present disclosure.

FIG. 3 is a diagram showing an SCMA codebook structure based on many-to-one preamble-to-codebook association according to one embodiment of the present disclosure.

FIG. 4 is a diagram for explaining a GF-SCMA system to which a many-to-one preamble-to-codebook association structure is applied according to one embodiment of the present disclosure.

FIG. 5 is a diagram showing a virtual transmission/reception model for base station receiver training according to one embodiment of the present disclosure.

FIG. 6 is a flowchart showing a process in which a receiving end receives preambles and data transmitted from a transmitting unit according to one embodiment of the present disclosure.

FIG. 7 is a diagram showing a structure of a deep learning-based collision-aware multi-user detector according to one embodiment of the present disclosure.

FIG. 8 is a diagram for explaining a channel-modulated codebook generation process in a preprocessor according to one embodiment of the present disclosure.

FIG. 9 is a diagram showing a procedure of generating a channel modulated codebook in a situation where two codebooks are activated according to one embodiment of the present disclosure.

FIG. 10 is a diagram showing a process of detecting data for each active user based on collision-aware multi-user detection (CA-MUD) according to one embodiment of the present disclosure.

FIG. 11 is a diagram showing a preprocessing process for acquiring channel modulated codebook information according to one embodiment of the present disclosure.

FIG. 12 is a diagram showing average BER performance according to codebook combinations when two codebooks are activated according to one embodiment of the present disclosure.

FIG. 13 is a diagram showing average BER performance according to codebook combinations when three codebooks are activated according to one embodiment of the present disclosure.

### DETAILED DESCRIPTION OF THE PREFERRED EMBODIMENT

Hereinafter, embodiments of the disclosure will be described in detail with reference to the accompanying drawings.

While describing embodiments of the disclosure, descriptions of techniques that are well known in the art and not directly related to the disclosure are omitted. This is to clearly convey the gist of the disclosure by omitting an unnecessary description.

For the same reasons, some elements are exaggerated, omitted, or schematically illustrated in the drawings. In addition, the size of each element may not substantially reflect its actual size. In each drawing, the same or corresponding element is denoted by the same reference numeral.

Advantages and features of the present disclosure, and methods of accomplishing the same will be clearly understood with reference to the following embodiments described below in detail in conjunction with the accompanying drawings. However, the present disclosure is not limited to those embodiments disclosed below but may be implemented in various different forms. It should be noted that the present embodiments are merely provided to make a full disclosure of the invention and also to allow those skilled in the art to know the full range of the invention, and therefore, the present disclosure is to be defined only by the scope of the appended claims. Like reference numerals refer to like elements throughout the specification. In addition, in describing the present disclosure, when it is determined that a specific description of a related function or configuration may unnecessarily obscure the subject matter of the present disclosure, the detailed description will be omitted. The terms described below are terms defined in consideration of the functions in the present disclosure, and may vary depending on the intention or custom of the user or operator. Therefore, the terms will be defined throughout the description of this specification.

Hereinafter, a base station is an entity that grants resources to a terminal and may be at least one of a gNode B (gNB), an eNode B (eNB), a node B, a base station (BS), a radio access unit, a base station controller, or a node on a network A terminal may include a user equipment (UE), a mobile station (MS), a cellular phone, a smartphone, a computer, or a multimedia system capable of performing a communication function.

In the present disclosure, a downlink (DL) denotes a wireless transmission path of a signal transmitted by a base station to a terminal, and an uplink (UL) denotes a wireless transmission path of a signal transmitted by a terminal to a base station,

In addition, although a long-term evolution (LTE) or LTE-advanced (LTE-A) system may be described as an example below, embodiments of the present disclosure may also be applied to other communication systems having similar technical backgrounds or channel types. For example, such communication systems may include 5th generation mobile communication systems (e.g., 5G or new radio (NR) systems) developed after LTE-A, and 5G below may be a concept including existing LTE, LTE-A, and other similar services. In addition, the present disclosure may be applied to other communication systems through some modifications without departing from the scope of the disclosure by the judgment of those skilled in the art.

Here, it will be understood that each block of processing flowchart diagrams and combinations of the flowchart diagrams may be performed by computer program instructions. These computer program instructions may be loaded into a processor of a general-purpose computer, special-purpose computer, or other programmable data processing equipment, and thus the instructions, which are executed via the processor of the computer or other programmable data processing equipment, generate a means for performing functions described in flowchart block(s). These computer program instructions may also be stored in a computer-executable or computer-readable memory that can direct the computer or other programmable data processing equipment to implement a function in a particular manner, and thus the instructions stored in the computer-executable or computer-readable memory may also produce an article of manufacture that includes instruction means for performing functions described in flowchart block(s). The computer program instructions may also be loaded into a computer or other programmable data processing equipment, a series of operational steps may be performed on the computer or other programmable data processing equipment to generate a process executed by the computer, and thus the instructions executed on the computer or other programmable data processing equipment may also provide steps for implementing functions described in flowchart block(s).

In addition, each block may represent a module, segment, or portion of code, which includes one or more executable instructions for implementing specified logical function(s). It should also be noted that in some alternative implementations, the functions noted in the blocks may occur out of the order. For example, two blocks shown in succession may in fact be executed substantially concurrently or the blocks may sometimes be executed in the reverse order, according to the functionality involved.

Here, the term “˜ unit” used in this embodiment refers to a software element or hardware element such as a field-programmable gate array (FPGA) or an application-specific integrated circuit (ASIC), and the “˜ unit” performs a specific function. However, the term “˜ unit” does not mean to be limited to software or hardware. The term “˜ unit” may be configured in a recording medium that can be addressed or may be configured to be reproduced on at least one processor. Therefore, as an example, the term “˜ unit” may include software elements, object-oriented software elements, elements such as class elements and task elements, processes, functions, attributes, procedures, subroutines, segments in program codes, drivers, firmware, microcodes, circuits, data, databases, data structures, tables, arrays, and variables. A function provided in elements and “˜ units” may be combined into a smaller number of elements and “˜ units” or sub-divided into additional elements and “˜ units.” In addition, elements and “˜ units” may also be implemented to operate one or more central processing units (CPUs) in a device or a secure multimedia card. In addition, in an embodiment, “˜ unit” may include one or more processors.

A wireless communication system is evolving from initially providing voice-oriented services to a broadband wireless communication system that provides a high-speed and high-quality packet data service, using communication standards such as 3rd generation partnership project (3GPP) high speed packet access (HSPA), long-term evolution (LTE) or evolved universal terrestrial radio access (E-UTRA), LTE-advanced (LTE-A), LTE-Pro, 3GPP2 high rate packet data (HRPD), ultra-mobile broadband (UMB), and the institute of electrical and electronics engineers (IEEE) 802.16e.

As a representative example of the broadband wireless communication system, the LTE system adopts an orthogonal frequency division multiplexing (OFDM) scheme in a downlink (DL) and a single carrier frequency division multiple access (SC-FDMA) scheme in an uplink (UL). The uplink refers to a radio link through which a terminal (a user equipment (UE) or a mobile station (MS)) transmits data or a control signal to a base station (BS) (e.g., eNode B), and the downlink refers to a radio link through which a base station transmits data or a control signal to a terminal. The above-described multiple access scheme may distinguish data or control information of each user by granting and operating time-frequency resources that are typically used to transmit data or control information to each user so as not to overlap each other, that is, so as to establish orthogonality.

As a post-LTE communication system, that is, a 5G communication system must be able to freely reflect various requirements of users and service providers, and therefore services that simultaneously satisfy various requirements must be supported. The services considered for the 5G communication system include enhanced mobile broadband (eMBB), massive machine type communication (mMTC), ultra reliability low latency communication (URLLC), and the like.

eMBB aims to provide improved data transmission speeds than those supported by existing LTE, LTE-A or LTE-Pro. For example, in the 5G communication system, eMBB must be able to provide a peak data rate of 20 Gbps in the downlink and a peak data rate of 10 Gbps in the uplink from the perspective of a single base station. In addition, the 5G communication system must provide a maximum transmission speed while also providing an increased user perceived data rate of the terminal. In order to satisfy such requirements, improvement of various transmission and reception technologies including a further improved multiple-input and multiple-output (MIMO) transmission technology are required. In addition, while signals are transmitted using a transmission bandwidth of up to 20 MHz in a 2 GHz band used by LTE, the 5G communication system may use a frequency bandwidth wider than 20 MHz in a 3 to 6 GHz or 6 GHz or higher frequency band to satisfy the data transmission speed required by the 5G communication system.

At the same time, mMTC is being considered to support application services such as the Internet of Things (IoT) in the 5G communication system. mMTC requires support for a large number of terminals within a cell, improved terminal coverage, improved battery life, and reduced terminal cost to efficiently provide the Internet of Things. The Internet of Things is attached to various sensors and various devices to provide a communication function, and thus, must be able to support a large number of terminals (e.g., 1,000,000 terminals/km²) within a cell. In addition, the terminal supporting mMTC is likely to be located in a shadow area that is not covered by the cell, such as a basement of a building due to the nature of the service, and thus may require wider coverage than other services provided by the 5G communication system. The terminal supporting mMTC must include a low-cost terminal and because it is difficult to frequently replace a battery of the terminal, a very long battery life time, such as 10 to 15 years, may be required.

Lastly, URLLC is a cellular-based wireless communication service used in a mission-critical manner. For example, services used for remote control of robots or machinery, industrial automation, unmanned aerial vehicles, remote health care, emergency alert, and the like may be considered. Therefore, communication provided by URLLC must provide very low latency and very high reliability. For example, a service supporting URLLC must satisfy an air interface latency of less than 0.5 milliseconds, while also having requirement of a packet error rate of 10-5 or less. Therefore, for a service supporting URLLC, the 5G system must provide a smaller transmit time interval (TTI) than other services, while simultaneously granting a wide resource in a frequency band to ensure the reliability of a communication link.

The three services of 5G, that is, eMBB, URLLC, and mMTC, may be multiplexed and transmitted by a single system. In this case, different transmission and reception techniques and transmission and reception parameters may be used between services to satisfy different requirements of respective services. Of course, 5G is not limited to the above-described three services.

The present disclosure considers a massive IoT system in which a number of Internet-of-Things (IoT) sensors (devices or users) are simultaneously multiple-accessed via uplink among intelligent 6G wireless access systems. In conventional 4G mobile communication standards, in order for a number of IoT devices to transmit data simultaneously via uplink, each user must be granted uplink resources required for data transmission through a grant. However, since IoT devices have a small amount of data being transmitted, individually granting resources to a number of IoT users through grants is very inefficient because it requires a lot of signal load for the request and grant process compared to the amount of data being transmitted. Therefore, a grant-free multiple access system has been considered, which activates only some of a plurality of user devices to transmit data symbols and pilot symbols simultaneously without a separate grant process.

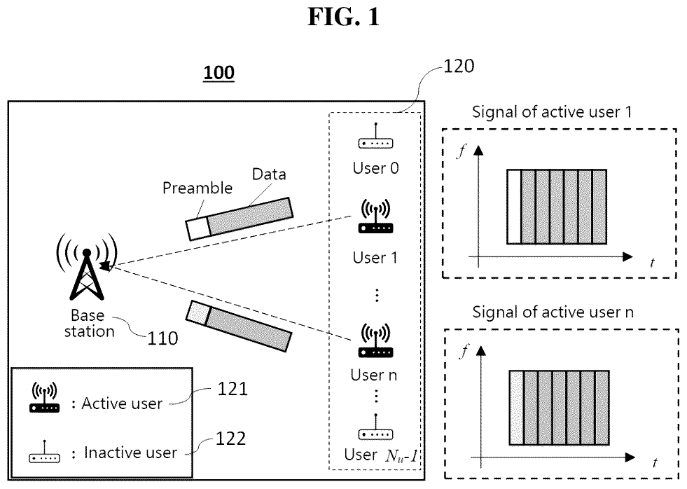

FIG. 1 is a diagram showing an example of a grant-free multiple access system model according to an embodiment of the present disclosure.

A grant-free multiple access system 100 according to one embodiment of the present disclosure may include a base station 110 and a plurality of users 120 performing wireless communication with the base station 110. In the following description of the present disclosure, unless specifically defined otherwise, a user may be understood as a concept including a terminal used by a user, i.e., a user equipment (UE), a mobile station (MS), a cellular phone, a smartphone, a computer, or a multimedia system capable of performing a communication function as described above.

Referring to FIG. 1, a plurality of users 120 of a grant-free multiple access system 100 according to one embodiment of the present disclosure are user 0, user 1 . . . user Nᵤ−1. Nᵤ represents a total number of users constituting the grant-free multiple access system 100. For Nᵤ according to one embodiment of the present disclosure, some of the plurality of users 120 in the grant-free multiple access system 100 may operate in an active state that transmits preambles and data to a base station, while other users may operate in an inactive state that does not transmit preambles and data to the base station. In the following description of the present disclosure, a user operating in an active state is called an active user 121, and a user operating in an inactive state is called an inactive user 122.

The active user may transmit preambles and data to the base station via uplink. In this case, the preamble may be transmitted via a pilot symbol, and data may be transmitted via a data symbol. In the example of FIG. 1, user 1 and user n may operate in active states, wherein the user 1 transmits pilot symbols and data symbols to the base station via uplink on time-frequency resources, and the user n transmits preambles and data to the base station via uplink on the time-frequency resources. The preambles and data transmitted by the active user may be received at the base station through a fading channel, respectively.

In an embodiment of the present disclosure, an active user may perform uplink transmission on resources where multiple users compete without a process of granting and granting separate physical resources for uplink transmission from a base station. A system in which users perform uplink transmission on the basis of competition without receiving a grant for resources is referred to as a grant-free multiple access system 100. In the grant-free multiple access system 100, since contention-based uplink transmission is performed on resources randomly selected by users without a process in which the base station 110 coordinates uplink resources of the plurality of users 120 so as not to overlap, pilot symbols or data symbols transmitted by respective active users may overlap one another. For example, resources used by user 1 of FIG. 1 to transmit pilot symbols or data symbols to the base station and resources used by user n to transmit pilot symbols or data symbols to the base station may overlap each other.

When data symbols of active users are transmitted in an overlapping manner in a grant-free multiple access, multiple access interference may be reduced by performing spreading on the data symbols. Spreading of data symbols may be performed based on a spreading sequence. When a length of the spreading sequence for performing the spreading for data symbols is K and a number of spreading sequences used is J, if J>K, then J non-orthogonal spreading sequences are generated. This type of grant-free multiple access scheme using non-orthogonal spreading sequences is referred to as a grant-free non-orthogonal multiple access (GF-NOMA) system. In the following description of the present disclosure, grant-free sparse codebook multiple access (GF-SCMA), which is a grant-free non-orthogonal multiple access system that uses sparse codebook multiple access (SCMA), which is a codebook-based spreading scheme, as a scheme of a non-orthogonal spreading sequence, will be described as an example. However, it should be noted that data spreading in the SCMA scheme is only an example of non-orthogonal spreading for GF-NOMA, and does not limit the scope of the present disclosure, and may be applied to GF-NOMA systems using various other non-orthogonal spreading schemes. Therefore, the content described based on GF-SCMA in the following description of the present disclosure may be applied to a general GF-NOMA system, and also, in the following description of the present disclosure, “codebook” as an expression used as an example of a spreading sequence used in a general GF-NOA system, the content described based on “codebook” may also be applied to a spreading sequence used in a general GF-NOMA system.

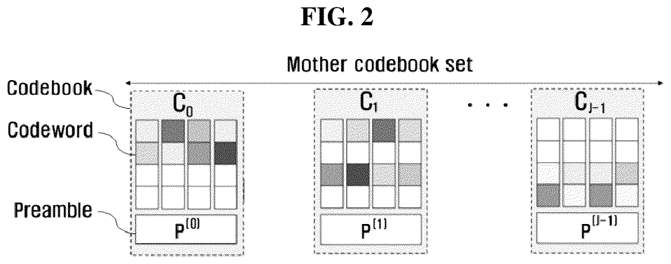

FIG. 2 is a diagram for explaining a structure of an SCMA codebook according to one embodiment of the present disclosure.

Referring to FIG. 2, a mother codebook set for SCMA, which is a codebook-based spreading scheme, may be defined as J codebooks, such as [symbol] ={ [symbol] [symbol] , . . . , [symbol] }. Here, a j-th codebook is defined as [symbol] (j=0, . . . , J−1), and each [symbol] may consist of M codewords of K dimensions. If an m-th codeword from among M codewords is represented by vector cₘ^{(j)}∈C^{K}, then a j-th codebook is given by [symbol] ={c₀^{(j)}, c₁^{(j)}, . . . , c_{M-1}^{(j)}}. When there are N non-zero elements in each codeword, cₘ^{(j)}∈C^{K} represents a sparse vector where N<K. The remaining K-N elements of each codeword may have values of 0. In this manner, the SCMA codebook is defined such that non-zero data is mapped only to N elements, which are a portion of a total length K, in each codeword that constitutes the codebook, and the remaining K-N elements have values of 0, thereby allowing interference to be reduced even when a plurality codebooks are activated simultaneously. Here, the codebook [symbol] may be associated with a specific preamble p^{(j)}.

Meanwhile, in large-scale machine communication, it is very inefficient to fix a unique codebook to each user, as an activity of each user is low and a number of codebooks that can actually be used is limited. Therefore, J codebooks must be reused by multiple users, and for this purpose, a codebook may be randomly selected and used from a mother codebook set when each user is activated. If the SCMA codebook is applied to a grant-free transmission system, then each active user randomly selects one of the J codebooks to perform data transmission, and thus there may occur a case where multiple active users perform data transmission using the same codebook. A situation where multiple active users use the same codebook is referred to as a codebook collision. The base station performs multi-user detection (MUD) to detect data on active users by using the codebook used by the active users to transmit signals, and thus the multi-user detection performance of the base station may deteriorate in a situation of codebook collision where multiple users transmit signals using the same codebook.

In a grant-free non-orthogonal multiple access system, even when the non-orthogonal codebooks of two different active users are the same, if the two users transmit signals through different channels, the base station may detect the data of the active user spread through the codebook using the channel. For example, even when two users transmit data using codewords of the same codebook, in a case where uplink data transmitted by the two users are transmitted to the base station over different channels, if the base station can estimate a channel between each user and the base station, then the uplink data transmitted by the two users may be respectively distinguished through the channel to perform multi-user detection. For this purpose, the channels of two users using the same codebook need to be accurately estimated. The base station may perform channel estimation using preambles transmitted from users, and associate multiple preambles with one codebook to accurately estimate the channels of two or more users using the same codebook. This is referred to as a many-to-one preamble-to-codebook association structure. When using the many-to-one preamble-codebook association, multiple preambles may be associated with a single codebook, and thus, even if the codebooks used by two different active users are the same, the preambles used by the active users may be different. Even when the same codebook is used as described above, if the preambles used are different, then the base station may perform multi-user detection through channel estimation using the preambles and may receive data transmitted by each active user in a distinguishable manner.

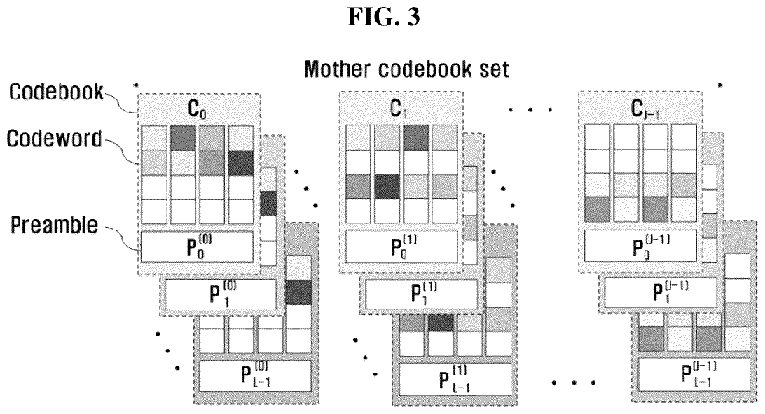

FIG. 3 is a diagram showing an SCMA codebook structure based on many-to-one preamble-to-codebook association according to one embodiment of the present disclosure.

Referring to FIG. 3, in a many-to-one preamble-codebook association structure, a mother codebook set for SCMA, which is a codebook-based spreading scheme, may be defined as J codebooks, such as [symbol] ={ [symbol] [symbol] , . . . , [symbol] } as shown in FIG. 2. Here, a j-th codebook is defined as [symbol] (j=0, . . . , J−1), each [symbol] consists of M codewords of K dimensions, and when an m-th codeword from among the M codewords is represented by a vector cₘ^{(j)}∈C^{K}, the j-th codebook is given as [symbol] ={c₀^{(j)}, c₁^{(j)}, . . . , c_{M-1}^{(j)}}. When there are N non-zero elements in each codeword, cₘ^{(j)}∈C^{K} represents a sparse vector where N<K. The remaining K-N elements of each codeword may have values of 0. In the many-to-one preamble-codebook association structure according to FIG. 3, unlike FIG. 2, it is shown that one codebook [symbol] is associated with L preambles p₀^{(j)}, p₁^{(j)}, . . . , p_{L-1}^{(j)}. Each active user may select one codebook from among J codebooks, and then select one of L preambles associated with the selected codebook to transmit an uplink, and as described above, even when the codebooks used by multiple active users are the same, if the preambles are different, then the base station may receive data in a distinguishable manner, and therefore, the data reception performance of the base station may be improved compared to a case where there is only one preamble associated with each codebook.

Meanwhile, a time interval during which contention-based transmission is performed in a GF-SCMA system is defined as a grant-free transmission opportunity interval. An active user may perform contention-based uplink transmission without any resource grant within a grant-free transmission opportunity interval. A single grant-free transmission opportunity interval may actually include a plurality of contention regions, which represent physical time-frequency resource regions over which contention-based uplink transmissions are performed. Active users may perform uplink transmissions distributed across a plurality of contention regions included in a given grant-free transmission opportunity interval. Contention-based transmission in such competitive regions is carried out based on contention transmission units (CTUs). A CTU is a unit in which contention-based transmission is performed in a GF-SCMA system and may be defined through a combination of time resources (e.g., slots), frequency resources (e.g., subbands), preambles, and codebooks.

In order to mitigate collisions of preambles during a contention process, a number of users accessing a single contention region may be controlled, but in addition, a sufficient number of preambles must be specified. However, when a unique NOMA spreading sequence (codebook) is assigned to each preamble, the probability of collision increases due to a limitation on the number of preambles in a case where a number of available codebooks is limited, such as SCMA. In order to overcome such a limitation, a plurality of different preambles may be associated with each codebook through many-to-one preamble-to-codebook association.

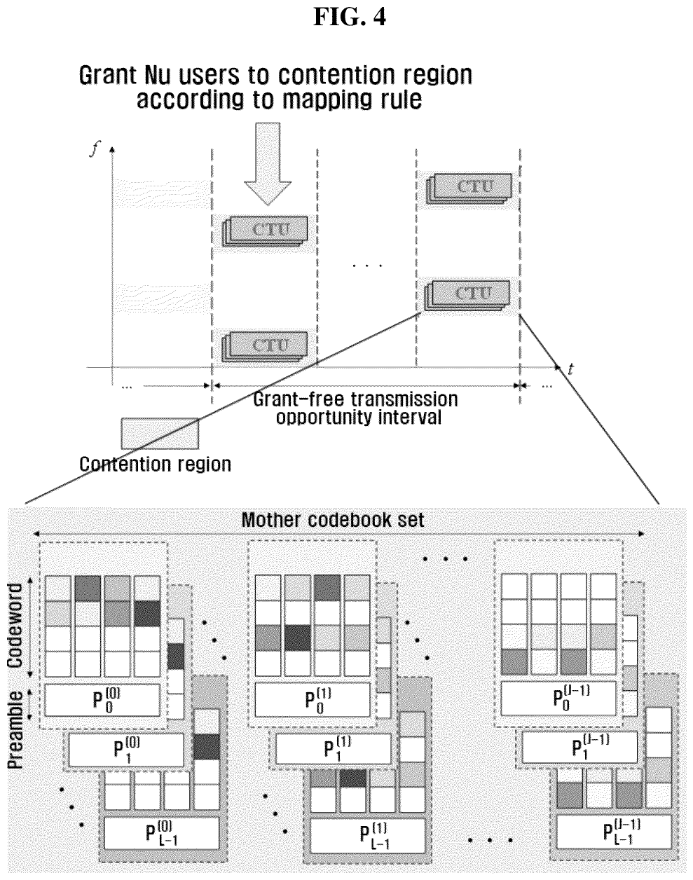

FIG. 4 is a diagram for explaining a GF-SCMA system to which a many-to-one preamble-to-codebook association structure is applied according to one embodiment of the present disclosure.

Referring to FIG. 4, it is shown that one grant-free transmission opportunity interval consists of NT contention regions, and a CTU is defined in each contention region. Users may perform transmissions distributed across NT contention regions in a given transmission interval. Here, J SCMA codebooks [symbol] , [symbol] , . . . , [symbol] may be defined in each contention region, and L preambles p₀^{(j)}, p₁^{(j)}, . . . , p_{L-1}^{(j)} may be defined in association with one another in each codebook [symbol] . Therefore, a total of N_{R}=J·L CTUs may be defined in one contention region. An active user performing transmission in each contention region may randomly select one of available J SCMA codebooks, and perform uplink transmission using one of preambles associated with the selected codebook. When successfully detecting the preamble of the active user, the base station may use the detected preamble to estimate a channel of the active user, and also determine which codebook the user has selected to subsequently perform a multi-user detection (MUD) procedure. In this manner, the number of CTUs may be increased by specifying multiple preambles for each codebook so as to enhance an uplink throughput for GF-NOMA.

Similar to the description described above through FIG. 3, a mother codebook set of the GF-SCMA system may be defined as J codebooks, such as [symbol] ={ [symbol] , [symbol] , . . . , [symbol] }. Here, the j-th codebook may be defined as [symbol] (j=0, . . . , J−1), and each [symbol] may consist of M codewords of K dimensions. If an m-th codeword from among M codewords is represented by a vector cₘ^{(j)}∈C^{K} then a j-th codebook is given by [symbol] ={c₀^{(j)}, c₁^{(j)}, . . . , c_{M-1}^{(j)}}. When the number of non-zero elements in each codeword is N, cₘ^{(j)}∈C^{K} represents a sparse vector that is N<K. Assuming that Nᵤ users are granted to the same contention region, the Nᵤ users select a CTU in the same contention region within a transmission opportunity interval. Here, Nᵤ represents a number of users identified by index n∈{0, 1, . . . , Nᵤ−1}. Among Nᵤ users, an active user may randomly select one of the defined CTUs in a given contention region to transmit preambles and data symbols to a time-synchronized base station.

The present disclosure proposes a training method of a base station receiver capable of resolving up to λ codebook collisions, when considering a GF-SCMA system to which a many-to-one preamble-codebook association structure is applied, and a multi-user detection method of the base station receiver based on the training method and an apparatus therefor. Here, resolving up to λ codebook collisions by the base station receiver may mean that even when up to λ users transmit uplink data using the same codebook, the base station may distinguish them to detect each user's data. For example, when λ=1, the base station only allows at most one codebook collision, which means that the base station cannot detect two or more data signals transmitted using the same codebook. As another example, when λ=2, it means that the base station can detect data signals transmitted using up to two identical codebooks, and when λ=3, it means that the base station can detect data signals transmitted using up to three identical codebooks. That is, when λ≥2, it means that the base station has the ability to resolve codebook collisions and detect data signals for each user even if two or more or up to λ pieces of data are transmitted using the same codebook.

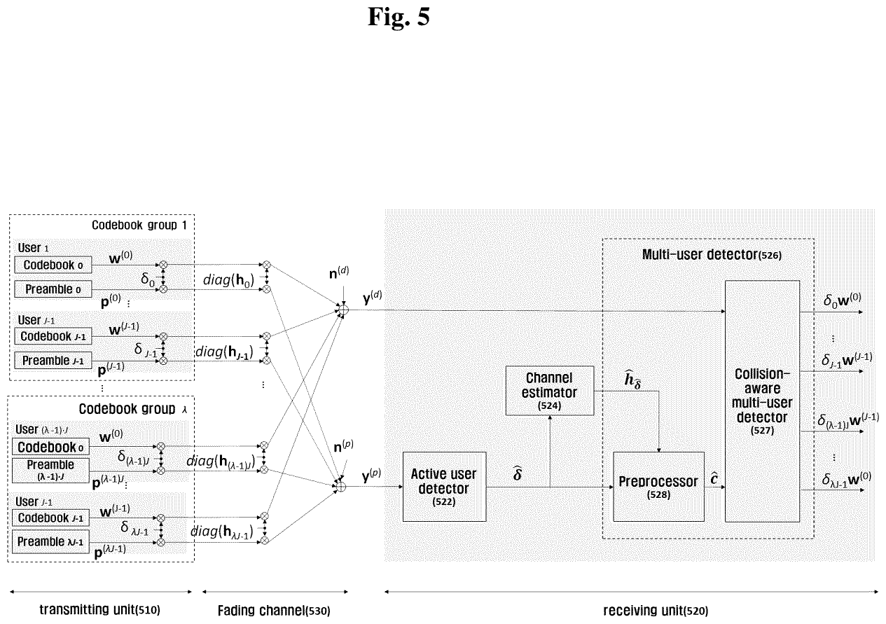

FIG. 5 is a diagram showing a virtual transmission/reception model for base station receiver training according to one embodiment of the present disclosure.

Referring to FIG. 5, a virtual transmission/reception model according to one embodiment of the present disclosure may be configured with a transmitting unit 510 and a receiving end 520. However, it should be noted that the transmission/reception model shown in FIG. 5 is a virtual model designed to train the receiving end to allow the base station to resolve up to λ codebook collisions, and the forms of the transmitting unit and the receiving end to which the present disclosure is actually applied are not limited to those shown in FIG. 5.

In the description of the present disclosure, uplink transmission based on GF-SCMA is assumed, and thus the transmitting unit 510 may consist of a plurality of users. The receiving end 520 may be a base station that receives an uplink transmitted from the transmitting unit 510. Therefore, in the description with reference to FIG. 5 below, the description for the user may be applied to the transmitting unit 510, the description for the base station may be applied to the receiving end 520, and vice versa.

According to one embodiment, it is assumed that the transmitting unit 510 consists of Nᵤ=λJ users in the form of J codebooks repeated A times. Here, Nᵤ=λJ users may be uniquely granted with a v(n)=mod(n, J)-th codebook in a round-robin scheme, and thus one codebook may be equally granted to/users. For example, codebook 0 may be granted to λ users corresponding to user 0, user J, . . . , user (λ−1)J, and codebook J−1 may be granted to λ users corresponding to user J−1, user ΔJ−1, . . . , user λJ−1. The receiving end may resolve up to A codebook collisions, and thus through the aforementioned transmitting unit model, training may be performed at the receiving end for the worst case scenario where λ codebook collisions occur. Additionally, it is assumed that collisions of preambles used at the transmitting unit do not occur by granting a unique preamble to each user.

Among all Nᵤ=λJ users at the transmitting unit, active users may transmit data by selecting N_{d} K-dimensional M-ary codewords from a codebook granted to themselves. Here, the probability that each user from among all Nᵤ=λJ users is active is assumed to follow a Bernoulli distribution. In FIG. 5, δₙ∈{0, 1} is an activation indicator of a n-th user, δₙ=1 indicates that the user is activated with a probability of pₙ, and δₙ=0 indicates that the user is not activated with a probability of 1−pₙ. An activation indicator, which indicates the active states of all users, may be represented by an activation vector δ=[δ₀, δ₁, . . . , δ_{N}_{ᵤ}₋₁]^{T}.

The CTU that is defined by preambles and data transmitted by each active user is transmitted to the base station over a fading channel 530. When the channel of an n-th user is represented as hₙ∈C^{K}, the channels of all users are given as a vector h=[h₀^{T}, h₁^{T}, . . . , h_{λJ-1}^{T}]^{T}.

The reception signals y^{(p)} and y^{(d)}, which are preambles and data received at the receiving end 520 through the channel 530, may be shown as in [Equation 1] and [Equation 2], respectively.

$${y}^{( p )} = {\sum }_{n = 0}^{λ J - 1} {δ}_{n} diag ( {h}_{n} ) {p}^{( n )} + {n}^{( p )} \qquad [ Equation 1 ]$$

$${y}^{( d )} = {\sum }_{n = 0}^{λ J - 1} {δ}_{n} diag ( {h}_{n} ) {w}^{v ( n )} + {n}^{( d )} \qquad [ Equation 2 ]$$

In [Equation 1] and [Equation 2], n^{(p)}˜ [symbol] (0, σ²I_{K}) and n^{(d)}˜ [symbol] (0, σ²I_{K}) represent additive white Gaussian noise (AWGN) vectors.

According to one embodiment, the receiving end 520 may perform multi-user detection (MUD) based on the reception signals y^{(p)} and y^{(d)} according to [Equation 1] and [Equation 2] to detect data for each active user. To this end, the receiving unit 520 according to an embodiment of the present disclosure may include an active user detector 522, a channel estimator 524, and a multi-user detector 526. Although not shown in FIG. 5, the receiving end 520 may include a transceiver that receives y^{(p)} and y^{(d)}, which are reception signals of preambles and data. The transceiver may receive y^{(p)} and y^{(d)}, and transmit them to the active user detector 522, the channel estimator 524, and/or the multi-user detector 526.

The active user detector 522 may detect an active preamble from y^{(p)}, which is reception signals of the preambles, to detect which user is active. The active user information acquired as a result of the detection by the active user detector 522 is given as a vector \hat{δ}=[\hat{δ}₀, \hat{δ}₁, . . . , \hat{δ}_{λJ-1}]^{T}, wherein \hat{δ}ₙ=1 indicates that an n-th user is detected in an active state, and \hat{δ}ₙ=0 indicates that the n-th user is detected in an inactive state. In this case, the preamble of the active user is associated with the codebook as described above in FIGS. 2 to 4, and thus when the user's activity information can be detected from the active codebook used for data transmission, it may help detect the activity information based on the associated preamble. For example, the active user detector 522 according to an embodiment of the present disclosure may detect the active status of each user by utilizing overlapping data symbols of active users spread through a codebook together to enhance the performance of the preamble-based active user detector.

The channel estimator 524 may perform channel estimation (CE) based on a preamble received from an active user detected through the active user detector 522. If the channel estimated for an n-th user is ĥₙ∈C^{K}, then channel information representing the channel estimated for all active users may be expressed as ĥ_{\hat{δ}}=[\hat{δ}₀ĥ₀^{T}, \hat{δ}₁ĥ₁^{T}, . . . , \hat{δ}_{λJ-1}ĥ_{λJ-1}^{T}]^{T}. ĥ_{\hat{δ}} is channel information estimated by reflecting a user's active state on each user's channel, and \hat{δ}ⱼĥⱼ^{T} has a value of ĥⱼ^{T} corresponding to the estimated channel for a j-th user when the j-th user is detected as an active state (\hat{δ}ⱼ=1), and has a value of 0 when the j-th user is detected as an inactive state (\hat{δ}ⱼ=0).

The multi-user detector 526 may detect data for active users from the received data signal. In the process of detecting an active preamble received from an active user at the receiving end 520, a codebook associated with the preamble may be known, and the multi-user detector 526 may perform multi-user detection using the codebook and the estimated channel.

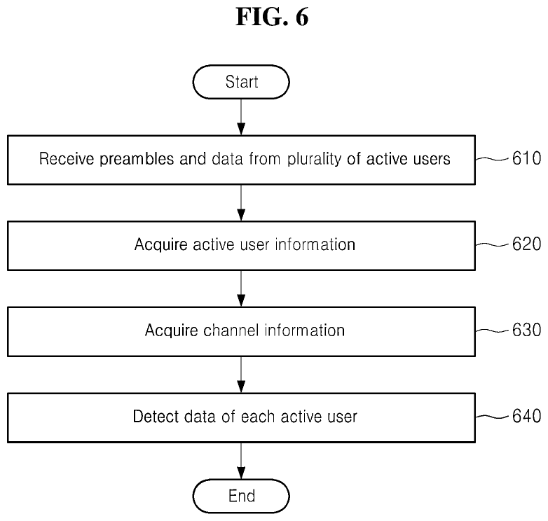

FIG. 6 is a flowchart showing a process in which a receiving end receives preambles and data transmitted from a transmitting unit according to one embodiment of the present disclosure.

Referring to FIG. 6, in step 610, a transceiver (not shown) of the receiving end may receive preambles and data from a plurality of active users among the users constituting the transmitting unit 610. The preamble and data transmitted by each active user are received at the receiving end through a fading channel, and the preamble signal y^{(p)} and the data signal y^{(d)} received at the receiving end may be expressed as [Equation 1] and [Equation 2].

In step 620, the active user detector 522 of the receiving end may detect an active user who has performed actual preamble and data transmission from among users constituting the transmitting unit based on the received preamble signals y^{(p)}, thereby acquiring active user information (620). Since the preamble of the active user is associated with a codebook, when the user's activity information can be detected from the active codebook used for data transmission, it may help detect the activity information based on the preamble associated therewith, and therefore, the detecting of the active user in step 620 may detect the active user using not only the preamble signal y^{(p)} but also the data signal y^{(d)}.

In step 630, the channel estimator 524 of the receiving end may by estimate channels related to the plurality of active users 630 to acquire channel information.

In step 640, the multi-user detector 526 of the receiving end may detect data for each active user from among the plurality of active users by using the active user information acquired through step 620 and the channel information acquired through step 630.

Since codebook collisions may occur in the process of grant-free transmission users randomly selecting codebooks and transmitting, the multi-user detector 526 needs to perform multi-user detection that takes such codebook collisions into account. This is referred to as collision-aware multi-user detection (CA-MUD). To this end, the multi-user detector 526 according to one embodiment of the present disclosure may include a collision-aware multi-user detector 527 and a preprocessor 528 that perform multi-user detection by considering codebook collision.

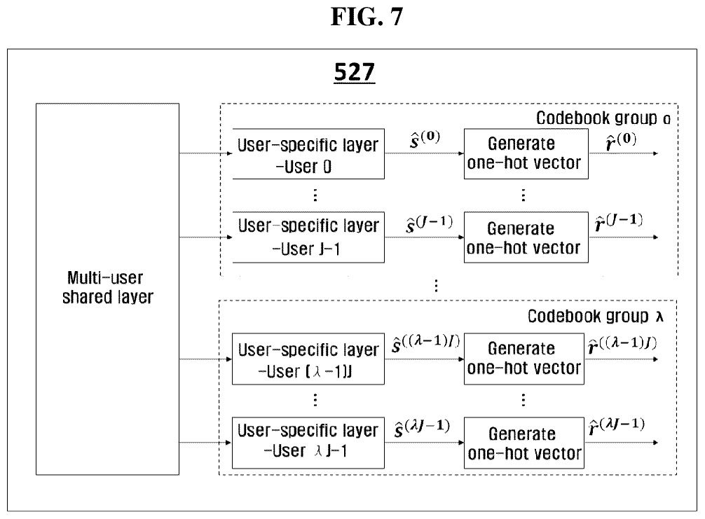

FIG. 7 is a diagram showing a structure of a deep learning-based collision-aware multi-user detector according to one embodiment of the present disclosure.

Referring to FIG. 7, the structure of the deep learning-based collision-aware multi-user detector 527 is designed to decode up to λ codebook collisions. Therefore, the collision-aware multi-user detector 527 must be able to handle a situation where up to λ codebook collisions occur due to multiple active users selecting codebooks duplicately. Therefore, the collision-aware multi-user detector 527 according to an embodiment of the present disclosure may have a two-stage structure as shown in FIG. 7 by introducing λ duplicate user-specific layers after a multi-user shared layer.

In a GF-SCMA system, the combination of codebooks received from the base station may be continuously changed. Since some codebooks may be deactivated during the process, this needs to be properly reflected in the output labels of the user-specific layers in FIG. 7. Therefore, the collision-aware multi-user detector 527 according to an embodiment of the present disclosure may generate a one-hot vector r⁽ⁿ⁾=[rₙ₀, rₙ₁, . . . , r_{nM}]^{T} of a total length of (M+1) by adding one label for 0 in addition to M code words present in the codebook. For example, when M=4, if the codebook of the n-th user is inactive, then r⁽ⁿ⁾=[1, 0, 0, 0, 0]^{T}, and if it is activated, then one of r⁽ⁿ⁾=[0, 1, 0, 0, 0]^{T} to [0, 0, 0, 0, 1]^{T} is considered as a label for the transmission signal. Then, a loss function for training the collision-aware multi-user detector 527 may be defined as a sum of cross-entropy as in [Equation 3] and [Equation 4] below.

$$L ( r , \hat{s} ) = {\sum }_{n = 0}^{λ J - 1} {L}_{n} ( {r}^{( n )} , {\hat{s}}^{( n )} ) \qquad [ Equation 3 ]$$

$${L}_{n} ( {r}^{( n )} , {\hat{s}}^{( n )} ) = - {\sum }_{m = 0}^{M} {r}_{n m} log ( {\hat{s}}_{n m} ) \qquad [ Equation 4 ]$$

Here, r and ŝ are given as

$$r = {[ {( {r}^{( 0 )} )}^{T} , {( {r}^{( 1 )} )}^{T} , … , {( {r}^{( λ J - 1 )} )}^{T} ]}^{T} and$$

$$\hat{s} = {[ {( {\hat{s}}^{( 0 )} )}^{T} , {( {\hat{s}}^{( 1 )} )}^{T} , … , {( {\hat{s}}^{( λ J - 1 )} )}^{T} ]}^{T} ,$$

respectively. Here, {ŝ⁽ⁱ⁾}ᵢ₌₀^{λJ-1} represents an output vector of a user-specific layer, {\hat{r}⁽ⁱ⁾}ᵢ₌₀^{λJ-1} represents a one-hot vector in which the maximum value of the {ŝ⁽ⁱ⁾}ᵢ₌₀^{λJ-1} vector is converted to 1 and the rest to 0. In this case, in CA-MUD according to an embodiment of the present disclosure, λ=Nₐ is set to consider all collision situations, wherein the dimension of the output vector is λ·J·(M+1)=Nₐ·J·(M+1) Then. {ŝ⁽ⁱ⁾}ᵢ₌₀^{λJ-1} is changed into one-hot vector {\hat{r}⁽ⁱ⁾}ᵢ₌₀^{λJ-1} to change into M-ary codeword of each active user, and the codeword may be decoded once more to detect the user's transmission bit b⁽ⁿ⁾∈B^{log}^{₂}^{M}.

As an example of a training data set, a tree-pruning-based training data set may be considered as follows. First, N_{CC} codebook activation combinations are considered for given {0, 1, . . . , J−1} codebooks. Then, for each codebook activation combination, M-ary codeword and a one-hot vector of length (M+1) representing an activity are granted. Lastly, duplicate codebook combinations are removed to ensure that there are no identical codebook combinations (permutation invariant) when the order is changed. Since there are M^{N}^{ₐ} possible codeword combinations for each Nₐ activated codebook combination, a total number of data is N_{CC}·M^{N}^{ₐ}. In this case, the data set may be set to detect all codebook collisions. The data generation scheme described above is an example, and does not limit the scope of the present disclosure.

In the GF-SCMA system, the active codebook and channel change according to the active user, that is, \hat{δ}, detected by the active user detector 524. Therefore, the multi-user detector 526 according to one embodiment of the present disclosure may include a preprocessor 528 that generates a channel modulated codebook vector through an active codebook and a channel of the corresponding codebook, and performs an input pre-processing process to input the generated channel modulated codebook to the collision-aware multi-user detector 527 so as to effectively perform a CA-MUD procedure that is performed by the collision-aware multi-user detector 527.

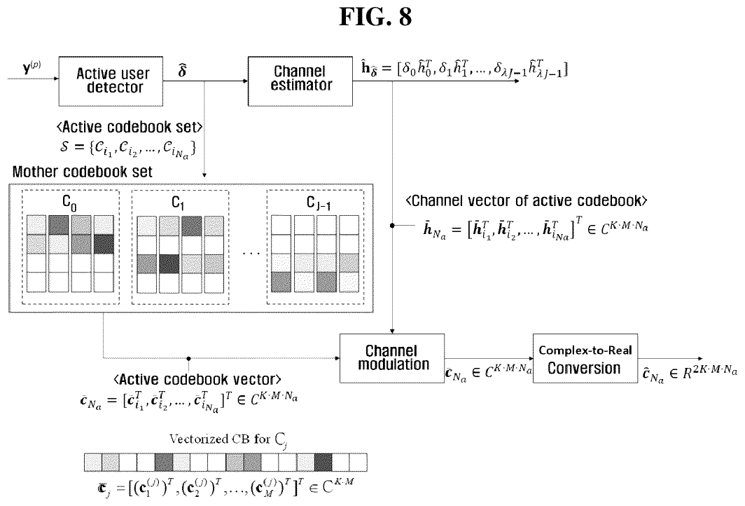

FIG. 8 is a diagram for explaining a channel-modulated codebook generation process in a preprocessor according to one embodiment of the present disclosure.

Referring to FIG. 8, the preprocessor 528 may first vectorize each of J codebooks [symbol] ={ [symbol] , [symbol] , . . . , [symbol] } of a mother codebook set. The j-th codebook [symbol] may be vectorized into c̅ⱼ=[(c₁^{(j)})^{T}, (c₂^{(j)})^{T}, . . . , (c_{M}^{(j)})^{T}]^{T}∈C^{K·M}. If a set of Nₐ activated codebooks identified from the active user detector 522 through the received preamble is

$$𝒮 = \{ {𝒞}_{{i}_{1}} , {𝒞}_{{i}_{2}} , … , {𝒞}_{{i}_{{N}_{a}}} \} ,$$

the preprocessor 528 may concatenate the set of Nₐ activated codebooks to generate an active codebook vector

$${\overline{c}}_{{N}_{a}} = {[ {\overline{c}}_{{i}_{1}}^{T} , {\overline{c}}_{{i}_{2}}^{T} , … , {\overline{c}}_{{i}_{{N}_{a}}}^{T} ]}^{T} ∈ {C}^{K \cdot M \cdot {N}_{a}} .$$

Meanwhile, if the channel for an active codebook [symbol] is ĥᵢ_{ₓ}∈C^{K}, then the preprocessor 528 may repeat the channel vector of the active codebook M times to generate a repeated channel vector h̅ᵢ_{ₓ}=[ĥᵢ_{ₓ}^{T}, ĥᵢ_{ₓ}^{T}, . . . , ĥᵢ_{ₓ}^{T}]^{T}∈C^{K·M} of the active codebook [symbol] . Then, the preprocessor 528 may concatenate a repeated channel vector h̅ᵢ_{ₓ} for each active codebook to generate an active channel vector h̅_{N}_{ₐ}=[h̅ᵢ_{₁}^{T}, h̅ᵢ_{₂}^{T}, . . . , h̅ᵢ_{_{Na}}^{T},]^{T}∈C^{K·M·N}^{ₐ}. Then, the preprocessor 528 may generate a channel modulated codebook vector \tilde{c}_{N}_{ₐ}=diag(h̅_{N}_{ₐ})·c̅_{N}_{ₐ}∈C^{K·M·N}^{ₐ} based on c̅_{N}_{ₐ} and h̅_{N}_{ₐ}. Lastly, the preprocessor 528 converts the channel modulated codebook vector into a real number vector ĉ_{N}_{ₐ}=[Re(ĉ), Im(ĉ)]∈R^{2K·M·N}^{ₐ} to be input to the collision-aware multi-user detector 527. In this manner, the real channel modulated codebook vectors ĉ_{N}_{ₐ} and y^{(d)} generated by the base station may be input to the collision-aware multi-user detector 527 so as to perform CA-MUD by utilizing the channel and codebook simultaneously.

Not only the received data y^{(d)} but also the channel modulated codebook generated from the preprocessor 528 may be input together to the collision-aware multi-user detector 527. Due to this, the collision-aware multi-user detector 527 may only learn the role of detecting which codewords are transmitted in an overlapping manner in y^{(d)} based on the currently activated input channel modulated codebook information, thereby increasing learning efficiency compared to directly inputting ĥ_{\hat{δ}} into the collision-aware multi-user detector 527.

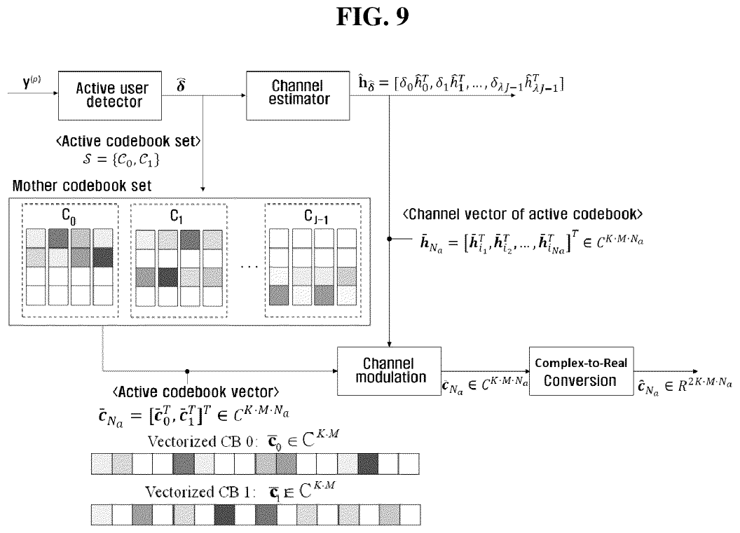

FIG. 9 is a diagram showing a procedure of generating a channel modulated codebook in a situation where two codebooks are activated according to one embodiment of the present disclosure.

Specifically, FIG. 9 illustrates a process of generating, by the preprocessor 526, a channel modulated codebook vector ĉ_{N}_{ₐ} for CA-MUD when two codebooks [symbol] ={ [symbol] , [symbol] } are activated. First, the preprocessor 526 may generate an active codebook vector c̅_{N}_{ₐ}=[c₀^{-T}, c₁^{-T}]^{T}∈C^{K·M·N}^{ₐ} through the active codebook index [symbol] ={ [symbol] , [symbol] } received from the active user detector 522. In addition, the preprocessor 526 may repeat the estimated channel vector {ĥ₀, ĥ₁}∈C^{K} of the active codebook generated by the channel estimator 524 M times to generate repeated channel vectors h̅₀=[ĥ₀^{T}, ĥ₀^{T}, ĥ₀^{T}, ĥ₀^{T}]^{T}∈C^{K·M} and h̅₁=[ĥ₀^{T}, ĥ₀^{T}, ĥ₀^{T}, ĥ₀^{T}]^{T}∈C^{K·M} of the active codebook. Then, the preprocessor 526 may connect the repeated channel vectors of each active codebook to generate an active channel vector h̅_{N}_{ₐ}=[h̅₀^{T}, h̅₁^{T}]^{T}∈C^{K·M·N}^{ₐ}, and generate a channel modulated codebook vector as \tilde{c}_{N}_{ₐ}=diag(h̅_{N}_{ₐ})·c̅_{N}_{ₐ}∈C^{K·M·N}^{ₐ}. Lastly, the preprocessor 526 may generate a real channel modulated codebook vector as ĉ_{N}_{ₐ}=[Re(ĉ), Im(ĉ)]∈R^{2K·M·N}^{ₐ} by converting a null modulated codebook vector into a real number, and use this vector together with y^{(d)} as input to the collision-aware multi-user detector.

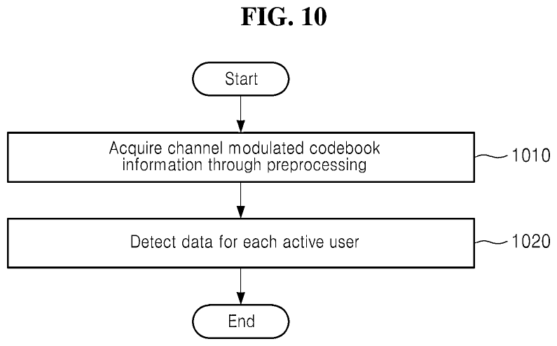

FIG. 10 is a diagram showing a process of detecting data for each active user based on collision-aware multi-user detection (CA-MUD) according to one embodiment of the present disclosure.

In step 1010, the preprocessor 528 of the multi-user detector 526 may generate a channel modulated codebook vector through an active codebook and a channel of the active codebook to effectively perform CA-MUD, and perform an input preprocessing process to perform CA-MUD through the generated channel modulated codebook.

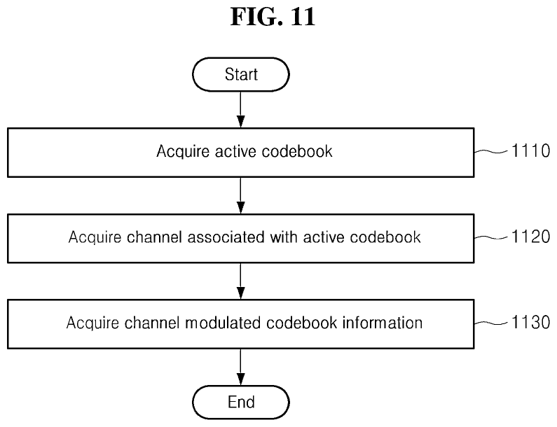

FIG. 11 is a diagram showing a preprocessing process for acquiring channel modulated codebook information according to one embodiment of the present disclosure.

In step 1110, the preprocessor may acquire information for an active codebook. According to one embodiment, for Nₐ active codebook sets

$$𝒮 = \{ {𝒞}_{{i}_{1}} , {𝒞}_{{i}_{2}} , … , {𝒞}_{{i}_{{N}_{a}}} \} ,$$

the Nₐ active codebook sets may be concatenated to be used in an operation for acquiring channel modulated codebook information so as to acquire an active codebook vector

$${\overline{c}}_{{N}_{a}} = {[ {\overline{c}}_{{i}_{1}}^{T} , {\overline{c}}_{{i}_{2}}^{T} , … , {\overline{c}}_{{i}_{{N}_{a}}}^{T} ]}^{T}$$

∈C^{K·M·N}^{ₐ} as information on the active codebook.

In step 1120, the preprocessor may acquire information on a channel associated with the active codebook. According to one embodiment, if a channel for an active codebook Cᵢ_{ₓ} is ĥᵢ_{ₓ}∈C^{K}, then a channel vector of the active codebook may be repeated M times to generate a repeated channel vector h̅ᵢ_{ₓ}=[ĥᵢ_{ₓ}^{T}, ĥᵢ_{ₓ}^{T}, . . . , ĥᵢ_{ₓ}^{T}]^{T}∈C^{K·M}, and the repeated channel vector h̅ᵢ_{ₓ} may be concatenated so as to use the repeated channel vector in an operation for acquiring a channel modulated codebook, thereby acquiring an active channel vector h̅_{N}_{ₐ}=[h̅ᵢ_{₁}^{T}, h̅ᵢ_{₂}^{T}, . . . , h̅ᵢ_{_{Na}}^{T}]^{T}∈C^{K·M·N}^{ₐ} as information on a channel associated with the active codebook.

In step 1130, the preprocessor may acquire channel modulated codebook information as \tilde{c}_{N}_{ₐ}=diag(h̅_{N}_{ₐ})·c̅_{N}_{ₐ}∈C^{K·M·N}^{ₐ} based on the active codebook vector c̅_{N}_{ₐ} generated by concatenating codewords of the active codebook acquired in step 1110, and the active channel vector h̅_{N}_{ₐ} generated by concatenating channels associated with the active codebook acquired in step 1120. The acquired channel modulated codebook information may be converted into a real vector to be uses as input to the collision-aware multi-user detector.

Returning again to the description of FIG. 10, in step 1020, the collision-aware multi-user detector 527 of the multi-user detector 526 may detect data for each active user using data received from a plurality of active users and channel modulated codebook information transmitted from the preprocessor 528.

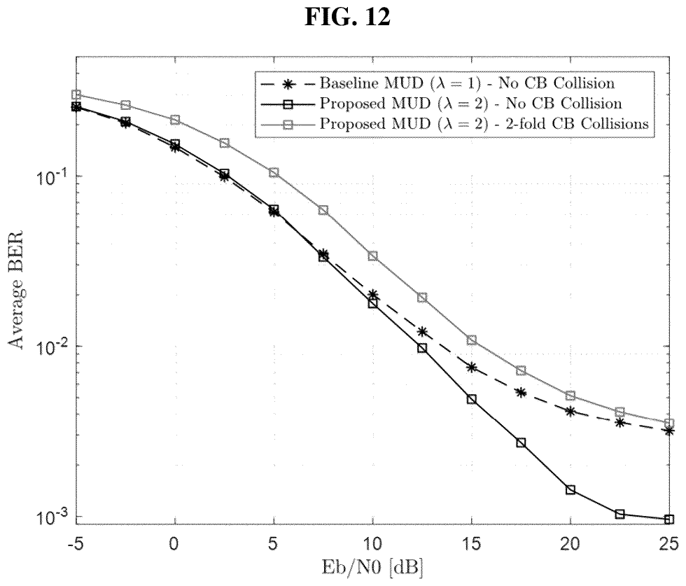

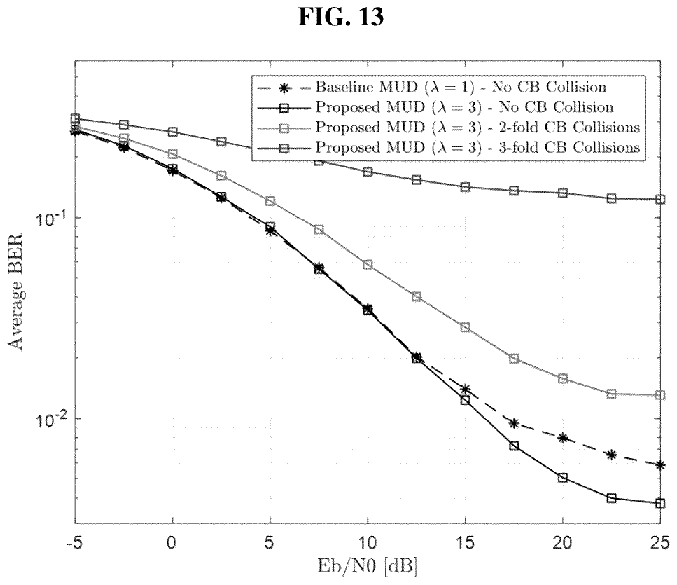

FIGS. 12 and 13 are graphs showing simulation results according to various embodiments of the present disclosure.

In this simulation, a GF-SCMA system using an SCMA codebook as a non-orthogonal spreading sequence is considered. Here, the SCMA codebook uses an M=4-ary codebook with J=6 for K=4 resources. In addition, this simulation assumes a situation where the number of active users Nₐ is Nₐ=λ≥2. That is, the worst performance is considered where CA-MUD receives all codebook collisions of λ=Nₐ when Nₐ users are active. Baseline MUD does not perform input preprocessing, and has channel ĥ_{\hat{δ}} as input. Both Baseline MUD and CA-MUD have multi-user-shared layers and user-specific layers consisting of three layers, and the number of nodes in each layer is set to {D₀^{(M)}, D₁^{(M)}, D₂^{(M)}}={512, 512, 256} and {D₀^{(S)}, D₁^{(S)}, D₂^{(S)}}={128, 128, 64}.

In this simulation, it is assumed that each user goes through an equally distributed uplink Rayleigh fading channel. In addition, additive white Gaussian noise (AWGN) is applied during network training so as to allow an Eb/N0 value to have a size of {8, 10, 12, 14, 16}, and in this case, random data of 2·10⁵ is generated from each Eb/N0 for training. Under ideal active user detection and channel estimation, it is assumed that the receiving end generates perfect ĉ_{N}_{ₐ}. An Adaptive Moment Estimation (Adam) optimizer is used, and it is assumed a batch size of 2000 and 2000 training epochs. In addition, it is trained for 1000 epochs with learning rate=0.001, and the learning rate is reduced to 0.0001 for the remaining 1000 epochs. CA-MUD was used through a loss function proposed in [Equation 3] and [Equation 4], and an average bit error rate (BER) was calculated with 5·10⁴ data samples.

FIG. 12 is a diagram showing average BER performance according to codebook combinations when two codebooks are activated according to one embodiment of the present disclosure.

Referring to FIG. 12, BERs are shown according to all codebook combinations when two codebooks are activated. In order to detect all N_{CC}=21 codebook activation combinations with Nₐ=2, CA-MUD of λ=2 is considered. When Nₐ=2, there are two cases where two identical codebooks are used (2-fold CB collisions) or two different codebooks are selected (no CB collision). FIG. 12 shows average BERs of all codebook combinations for these two cases. First, it can be seen that the proposed CA-MUD has the same or better performance than the baseline MUD in a wider SNR range in the case of no CB collision in FIG. 12. This is because CA-MUD can be trained more effectively by ĉ generated by input preprocessing than by inputting ĥ_{\hat{δ}} as input. In particular, CA-MUD has higher training efficiency at a high SNR because codebook information is provided in addition to the channel. In addition, the proposed CA-MUD may successfully distinguish up to 2-fold CB collisions, unlike the baseline MUD. That is, as shown in Embodiment 1, even when two codebooks collide, reception is enabled with less than 3 dB of performance degradation at BER=10⁻².

FIG. 13 is a diagram showing average BER performance according to codebook combinations when three codebooks are activated according to one embodiment of the present disclosure.

FIG. 13 shows the performance of CA-MUD in a situation of Nₐ=λ=3. As shown in FIG. 12, one CA-MUD is designed to detect all codebook activation combinations of Nₐ=3. In this case, in the situation of Nₐ=3, there are cases of no CB collision, 2-fold codebook collisions, and 3-fold CB collisions. Therefore, one CA-MUD with λ=3 is designed to receive all codebook combinations with Nₐ=3. Referring to FIG. 13, in a case where there is no codebook collision, CA-MUD with λ=3 shows better BER performance than baseline-MUD. This is a performance gain resulting from efficient MUD training through input preprocessing. In addition, it can be seen that the proposed CA-MUD successfully performs MUD for 2-fold CB collision cases even in the case of Nₐ=3. Finally, in the case of 3-fold collisions, there are 3 M-ary codebooks overlap in one resource, and have poor performance because no resource diversity can be obtained, but it can still be seen that the average BER performance decreases as Eb/NO increases.

According to various embodiments of the present disclosure as described above, a single deep learning-based multi-user detector network may perform multi-user detection on received data using a number of combinations of codebooks (spreading sequences), thereby reducing reception complexity and cost.

Furthermore, according to various embodiments of the present disclosure, instead of inputting a channel vector as side-information for designing (training) a multi-user detector as it is into a multi-user detector, the multi-user detector may be effectively trained by considering a vector that simultaneously considers a codebook and a channel through an input preprocessing process as side information, thereby increasing training efficiency and final bit error rate performance.

In addition, according to various embodiments of the present disclosure, a generalized deep learning-based multi-task learning MUD structure may be proposed to distinguish up to λ codebook collisions through λ different user-specific layers, and allow the deep learning-based MUD to distinguish even codebook collisions, thereby allowing a receiver to detect each user's data through a channel even when there occur λ collisions with the same codebook.

Methods according to embodiments described in the claims or specification of the present disclosure may be implemented in the form of hardware, software, or a combination of hardware and software.

When implemented in software, a computer-readable storage medium storing one or more programs (software modules) may be provided. One or more programs stored in a computer-readable storage medium are configured for execution by one or more processors in an electronic device. One or more programs include instructions that allow the electronic device to execute the methods according to the claims of the present disclosure or the embodiments described in the specification.

Those programs (software modules or software) may be stored in a random access memory, a non-volatile memory including a flash memory, a read-only memory (ROM), an electrically erasable programmable read-only memory (EEPROM), a magnetic disc storage device, a compact disk-ROM (CD-ROM), digital versatile discs (DVDs), other types of optical storage devices, or magnetic cassettes. Alternatively, the programs may be stored in a memory configured as a combination of some or all of those. In addition, each configuration memory may include multiple elements.

Additionally, the programs may be stored in an attachable storage device that is accessible via a communication network, such as the Internet, an intranet, a local area network (LAN), a wide LAN (WLAN), or a storage area network (SAN), or a combination thereof. Such a storage device may be connected to a device performing an embodiment of the present disclosure via an external port. Furthermore, a separate storage device on the communications network may be connected to a device performing an embodiment of the present disclosure.

In the specific embodiments of the present disclosure described above, the elements included in the disclosure are expressed in a singular or plural form according to the specific embodiment presented. However, the singular or plural expressions are selected appropriately for the situations presented for convenience of explanation, and the present disclosure is not limited to singular or plural elements, and a single element may be provided even if the element is expressed in a plural form, and a plurality of elements may be provided even if the element is expressed in a singular form.

Meanwhile, the embodiments of the present disclosure disclosed in this specification and drawings are only specific examples presented to easily explain the technical description of the present disclosure and help in understanding the present disclosure, and are not intended to limit the scope of the present disclosure. That is, it will be apparent to those skilled in this art that various modifications based on the technical concept of the present disclosure can be made thereto. In addition, the respective embodiments may be combined and operated in combination as needed. For example, parts of one embodiment and another embodiment of the present disclosure may be combined to operate a base station and a terminal.

Meanwhile, the order of description in the drawings explaining the method of the present disclosure does not necessarily correspond to that of execution, and the order relationship may be changed or executed in parallel.

Alternatively, the drawings explaining the method of the present disclosure may omit some elements and include only some elements within a range that does not impair the essence of the present disclosure.

In addition, the method of the present disclosure may be implemented by combining part or all of the description included in each embodiment within a range that does not impair the essence of the disclosure.

Various embodiments of the present disclosure have been described above. The foregoing description of the present disclosure is intended to be illustrative, and embodiments of the present disclosure are not limited to the disclosed embodiments. It will be apparent to those skilled in the art to which the present disclosure pertains that the present disclosure can be easily modified in other specific forms without departing from the technical concept and essential characteristics thereof. The scope of the present disclosure is defined by the appended claims rather than by the detailed description, and all changes or modifications derived from the meaning and range of the appended claims and equivalents thereof should be construed to be embraced by the scope of the present disclosure.

What is claimed is:

1. A wireless communication system based on grant-free non-orthogonal multiple access (GF-NOMA), the system comprising:
a transmitting unit comprising a plurality of active users transmitting preambles and data in a grant-free manner without granting resources for data transmission; and
a receiving unit that receives preambles and data transmitted from the plurality of active users in a grant-free manner, and detects data corresponding to each active user from among the plurality of active users,
wherein each active user from among the plurality of active users transmits the data based on a codebook, and
wherein the codebook is a codebook randomly selected by the each active user from a preset codebook set.

2. The system of claim 1, wherein all active users from among the plurality of active users transmit the data based on different codebooks, or at least two active users from among the plurality of active users transmit the data based on the same codebook.

3. The system of claim 1, wherein the receiving end comprises:
an active user detector that detects the plurality of active users based on the preambles to acquire active user information;
a channel estimator that estimates channels related to the plurality of active users to acquire channel information; and
a multi-user detector that detects data corresponding to each active user from among the plurality of active users based on the active user information and the channel information.

4. The system of claim 3, wherein the multi-user detector comprises:
a preprocessor that performs preprocessing based on the active user information and the channel information to acquire channel modulated codebook information; and
a collision-aware multi-user detector that detects data corresponding to each active user from among the plurality of active users based on data received from the plurality of active users and the channel modulated codebook information.

5. The system of claim 4, wherein at most λ active users from among the plurality of active users transmit the data based on the same codebook.

6. The system of claim 5, wherein the collision-aware multi-user detector comprises:
a multi-user shared layer and duplicate user-specific layers as many as λ.

7. The system of claim 6, wherein the collision-aware multi-user detector is trained by using L(r, ŝ)=Σₙ₌₀^{λJ-1}Lₙ(r⁽ⁿ⁾, ŝ⁽ⁿ⁾) as a loss function,
wherein Lₙ(r⁽ⁿ⁾, ŝ⁽ⁿ⁾)=−Σₘ₌₀^{M}rₙₘ log(ŝₙₘ),
J is a number of codebooks included in the preset codebook set,
M is a number of codewords included in each codebook,
ŝ⁽ⁿ⁾ is an output vector of an n-th user-specific layer, and
r⁽ⁿ⁾ is a one-hot vector generated based on the ŝ⁽ⁿ⁾.

8. The system of claim 4, wherein the preprocessor is configured to:
acquire an active codebook based on the active user information,
acquire a channel associated with the active codebook based on the channel information, and
acquire the channel modulated codebook information based on the channel associated with the active codebook and the active codebook.

9. A receiving end apparatus of a wireless communication system based on grant-free non-orthogonal multiple access (GF-NOMA), the apparatus comprising:
a transceiver that receives preambles and data from a plurality of active users;
an active user detector that detects the plurality of active users based on the preambles to acquire active user information;
a channel estimator that estimates channels related to the plurality of active users based on the active user information and the channel information to acquire channel information; and
a multi-user detector that detects data corresponding to each active user from among the plurality of active users.

10. The apparatus of claim 9, wherein all active users from among the plurality of active users transmit the data based on different codebooks, or at least two active users from among the plurality of active users transmit the data based on the same codebook.

11. The apparatus of claim 9, wherein the multi-user detector comprises:
a preprocessor that performs preprocessing based on the active user information and the channel information to acquire channel modulated codebook information; and
a collision-aware multi-user detector that detects data corresponding to each active user from among the plurality of active users based on data received from the plurality of active users and the channel modulated codebook information.

12. The apparatus of claim 11, wherein data corresponding to at most λ active users from among the plurality of active users are associated with the same codebook.

13. The apparatus of claim 12, wherein the collision-aware multi-user detector comprises:
a multi-user shared layer and duplicate user-specific layers as many as 2.

14. The apparatus of claim 13, wherein the collision-aware multi-user detector is trained by using L(r, ŝ)=Σₙ₌₀^{λJ-1}Lₙ(r⁽ⁿ⁾, ŝ⁽ⁿ⁾) as a loss function,
wherein Lₙ(r⁽ⁿ⁾, ŝ⁽ⁿ⁾)=−Σₘ₌₀^{M}rₙₘ log(ŝₙₘ),
J is a number of codebooks included in the preset codebook set,
M is a number of codewords included in each codebook,
ŝ⁽ⁿ⁾ is an output vector of an n-th user-specific layer, and
r⁽ⁿ⁾ is a one-hot vector generated based on the ŝ⁽ⁿ⁾.

15. The apparatus of claim 11, wherein the preprocessor is configured to:
acquire an active codebook based on the active user information,
acquire a channel associated with the active codebook based on the channel information, and
acquire the channel modulated codebook information based on the channel associated with the active codebook and the active codebook.

16. A method performed by a receiving end of a wireless communication system based on grant-free non-orthogonal multiple access (GF-NOMA), the method comprising:
receiving preambles and data from a plurality of active users;
detecting the plurality of active users based on the preambles to acquire active user information;
estimating channels related to the plurality of active users to acquire channel information; and
detecting data corresponding to each active user from among the plurality of active users based on the active user information and the channel information,
wherein data corresponding to each active user from among the plurality of active users is associated with a codebook randomly selected by each active user from among the plurality of active users.

17. The method of claim 16, wherein all active users from among the plurality of active users transmit the data based on different codebooks, or at least two active users from among the plurality of active users transmit the data based on the same codebook.

18. The method of claim 16, wherein the detecting of data corresponding to each active user from among the plurality of active users comprises:
performing preprocessing based on the active user information and the channel information to acquire channel modulated codebook information; and
detecting data corresponding to each active user from among the plurality of active users based on data received from the plurality of active users and the channel modulated codebook information.

19. The method of claim 18, wherein data corresponding to at most λ active users from among the plurality of active users are associated with the same codebook.

20. The method of claim 18, wherein the acquiring of channel modulated codebook information comprises:
acquiring an active codebook based on the active user information;
acquiring a channel associated with the active codebook based on the channel information; and
acquiring the channel modulated codebook information based on the channel associated with the active codebook and the active codebook.
